(19) United States
(12) Patent Application Publication
(10) Pub. No.: US 2026/0111343 A1
(43) Pub. Date: Apr. 23, 2026

(54) SYSTEMS AND METHODS FOR COMPREHENSIVE SOFTWARE CODE EVALUATION AND RANKING USING LARGE LANGUAGE MODELS

(71) Applicant: UST Global Inc, Aliso Viejo, CA (US)

(72) Inventors: Alla Abdella, Aliso Viejo, CA (US); Adnan Masood, Temple Terrace, FL (US); Richard Muirhead, Aliso Viejo, CA (US)

(21) Appl. No.: 18/924,606

(22) Filed: Oct. 23, 2024

(51) Int. Cl. G06F 11/36; G06F 8/35

(52) U.S. Cl. CPC G06F 11/3616; G06F 8/35

(57) ABSTRACT

A system for translating source code in a first programming language to a target language is provided. The system is configured to obtain metrics specifications associated with an expected behavior; generate one or more code candidates; evaluate the one or more code candidates to obtain metrics specifications associated with each of the one or more code candidates; score each of the one or more code candidates based on a set of criteria; and based on the determined scores, select a target code from the one or more candidates.

### FIELD

The present invention relates generally to optimizing large language models for automatically evaluating items, and more specifically, to computing systems and methods for using large language models as judges for codebase conversion, code base synthesis, and codebase selection based on a set of criteria.

### BACKGROUND

Everyday activities involve distinguishing one item from another. For example, in the context of shopping, a customer may enter a store and is confronted with multiple television sets. The customer may then engage in a process of eliminating one or more televisions to finally select one television for purchase. During elimination, the customer may consider price, contrast ratio, brand, standby power, bundles associated with each television set, etc. In another example, in product engineering, a manufacturer may generate various prototypes and evaluate the prototypes based on cost to manufacture, heat response of each prototype, structural integrity of each prototype, etc. Almost all activities where a choice must be made involves some level of distinguishing items from each other using some set of criteria. With the explosion of digital content generation, evaluating each generated content has become more difficult due to the vast number of content that can be generated.

In some examples, video content can be generated using generative artificial intelligence models. In some examples, text, audio, and multi-modal content can be generated. There is a lot more competition for individuals' attention. Content creators (e.g., writers, bloggers, vloggers, musicians, etc.) make editorial choices on what content they put out to consumers. Similarly, consumers make choices on what content they finally consume. Criteria for evaluating the same content may be different between the content creator and the consumer. The present disclosure provides systems and methods that can be used to automatically evaluate content based on criteria that can be tuned by the content creator or the consumer. As such, the explosion of content does not overwhelm the consumer when selecting content to enjoy. Similarly, the content creator can be certain of a standard associated with the creative work she sanctions even when she uses generative artificial intelligence models to create such creative work.

In another example, code conversion and code synthesis can benefit from systems and methods of the present disclosure. Early attempts of translating code from one language to another were largely manual, time-consuming and error-prone, leading to the development of automated tools. In software development, the automatic generation of code from specifications or the translation of code between programming languages has been fraught with challenges. The initial phase of automated translation focused on direct syntax conversion, often termed “source-to-source” translation. These tools parsed source code into an intermediate representation, which was then used to generate code in the target language. This approach frequently struggled with idiomatic constructs and semantic discrepancies between languages, leading to functionally incorrect or suboptimal translations.

As programming languages evolved, so did the complexity of code translation tasks. One significant challenge was maintaining the functional integrity and performance characteristics of the original code, especially when translating between languages with different paradigms (e.g., procedural to object-oriented). Another challenge was handling context-sensitive information, such as variable scoping and type inference, which are not always explicitly defined in the source code but crucial for accurate translation.

Traditional methods often produce code that contains inaccuracies, hallucinations, and inefficiencies. Traditional methods render the use of automatically generated code largely unusable. The present disclosure is directed at evaluating automatically generated code and possibly improving such code.

### SUMMARY

According to some implementations of the present disclosure, a system is provided. The system includes one or more data processors and a non-transitory computer-readable storage medium containing instructions. When the instructions are executed on the one or more data processors, the one or more data processors perform operations that include obtaining metrics specifications associated with an expected behavior, generating one or more code candidates, evaluating the one or more code candidates to obtain metrics specifications associated with each of the one or more code candidates, scoring each of the one or more code candidates based on a set of criteria, and based on the determined scores, selecting a target code from the one or more candidates.

According to some implementations of the present disclosure, a method is provided. The method includes (a) obtaining metrics specifications associated with an expected behavior; (b) generating one or more code candidates; (c) evaluating the one or more code candidates to obtain metrics specifications associated with each of the one or more code candidates; (d) scoring each of the one or more code candidates based on a set of criteria; and (e) based on the determined scores, selecting a target code from the one or more candidates.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 illustrates a block diagram of a system for code evaluation using a large language model, according to certain aspects of the present disclosure.

FIG. 2 is a flow diagram of a process for translating code from a source code to a target code, according to certain aspects of the present disclosure.

FIG. 3 is a flow diagram of a process for evaluating items, according to certain aspects of the present disclosure.

### DETAILED DESCRIPTION

Code conversion and synthesis are challenging tasks that require preserving syntax, semantics and non-functional attributes. Traditional rule-based systems struggle to handle the intricacies of modern programming. While large language models (LLMs) have shown promising code generation capabilities, using them solely for generation does not ensure the correctness, efficiency, or consistency of the output. Recent research in LLM-as-a-Judge, such as JudgeLM, MT-Bench, and PandaLM, has demonstrated the potential of fine-tuned LLMs to act as scalable, precise judges for open-ended coding tasks. However, existing methods do not address diversity, judgment criteria, and inherent biases.

In some implementations, the present disclosure presents a system and method for converting and synthesizing codebases using LLMs and employing these models as “judges” to evaluate and select the best code based on correctness, quality, and consistency. The system integrates knowledge distillation, LLM-based weights, reinforcement learning with human feedback (RLHF), bias mitigation techniques, and execution-based feedback to discern the most accurate and optimal code among potential candidates. Factors considered in the judging process may include compiler execution results, adherence to coding conventions, cyclomatic complexity, explainability, maintainability, code documentation, and test coverage. Some implementations of the present disclosure leverage advancements in LLMs' abilities to generate, evaluate, execute and refine code, offering solutions to the complex problems of code synthesis, conversion, and maintenance.

In some implementations, the present disclosure presents systems and methods that perform code synthesis using LLMs to obtain code candidates, perform code execution to generate feedback concerning the synthesized code candidates, evaluate the code candidates on multiple criteria using a fine-tuned LLM judge, refine the fine-tuned LLM judge using knowledge distillation, obtain expert feedback and incorporate LLM-based weights and RLHF to align models with the expert feedback, and select optimal code. The systems and methods also address biases in LLM judging through swap augmentation, reference support, and reference drop.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The following are definitions of terms used in this disclosure that relate in general to LLM-based code synthesis and judging systems.

Large language models (LLMs) are artificial intelligence models trained on vast amounts of text data, capable of understanding and generating human-like text, including code.

Code synthesis is a process of generating code based on given requirements using AI models like LLMs.

Code conversion is a process of transforming code from one programming language to another while preserving functionality and other attributes.

An LLM code synthesizer is an LLM specifically trained to generate code based on input requirements.

An LLM code executor is an engine that compiles and runs the generated code to collect execution-based feedback.

An LLM judge is an LLM fine-tuned to evaluate code, based on various criteria (e.g., correctness, quality, efficiency, and maintainability, etc.).

Knowledge distillation is a technique used to transfer knowledge from a large, complex model (i.e., a teacher) to a smaller, simpler model (i.e., a student) by training the student to mimic the teacher's outputs.

LLM-based weights are learned weights assigned to different evaluation criteria, predicted by an LLM based on the code and requirements.

Reinforcement learning with human feedback (RLHF) is a learning paradigm where the LLM is fine-tuned based on rewards derived from human feedback to align outputs of the LLM with preferences of a user providing the human feedback.

A transformer architecture is a neural network architecture based on self-attention mechanisms that can be used in LLMs for processing sequential data like text and code.

Multi-head attention is a component of the transformer architecture that allows the model to attend to different parts of an input sequence simultaneously.

Positional encoding is a technique used in transformers to inject information about the position of tokens in the input sequence, allowing the model to capture positional dependencies.

Softmax function is a mathematical function that converts a vector of real numbers into a probability distribution, often used in the output layers of LLMs.

Cross-entropy loss is a loss function, used in training LLMs, that measures the dissimilarity between the predicted and true probability distributions.

Mean squared error loss is a loss function that measures the average squared difference between the predicted and true values and can be used in regression tasks like score prediction.

Gradient descent is an optimization algorithm used to update model parameters in a direction that minimizes the loss function.

Learning rate is a hyperparameter that controls the step size at which the model's parameters are updated during training.

Attention mechanism is a technique that allows a model to focus on specific parts of an input sequence when making predictions, by computing a weighted sum of the input representations.

Residual connections describes an architectural design in neural networks where the input to a layer is added to its output, allowing for better gradient flow and easier training of deep models.

Layer normalization is a technique for normalizing the activations of a layer in a neural network, helping to stabilize training and improve generalization.

Teacher forcing is a training technique where the model's predictions are conditioned on the ground truth outputs from the previous time steps, rather than its own predictions.

Beam search is a decoding algorithm used to generate text from LLMs, which maintains a set of top-k candidate sequences at each step and explores them in parallel.

Nucleus sampling is a stochastic decoding method for LLMs that samples from the top-p portion of the probability distribution, allowing for more diverse and coherent outputs.

Perplexity is an evaluation metric for language models that measures how well the model predicts a given sequence of text, expressed as the exponential of the cross-entropy loss.

BLEU score is a metric for evaluating the quality of generated text by comparing the generated text to one or more reference texts, based on n-gram overlap.

Cyclomatic complexity is a software metric that measures the complexity of a program by counting the number of linearly independent paths through its source code.

Maintainability index is a composite metric that incorporates several code quality attributes, such as lines of code, cyclomatic complexity, and code duplication, to provide an overall measure of code maintainability.

Code documentation is the practice of adding explanatory comments and annotations to the source code to improve its readability and understandability for other developers.

Test coverage is a measure of the degree to which a software system's source code is executed during automated testing, expressed as a percentage of code lines, branches, or paths covered.

Compiler optimization are techniques used by compilers to improve the performance, size, or efficiency of the generated machine code, such as dead code elimination, constant folding, and loop unrolling.

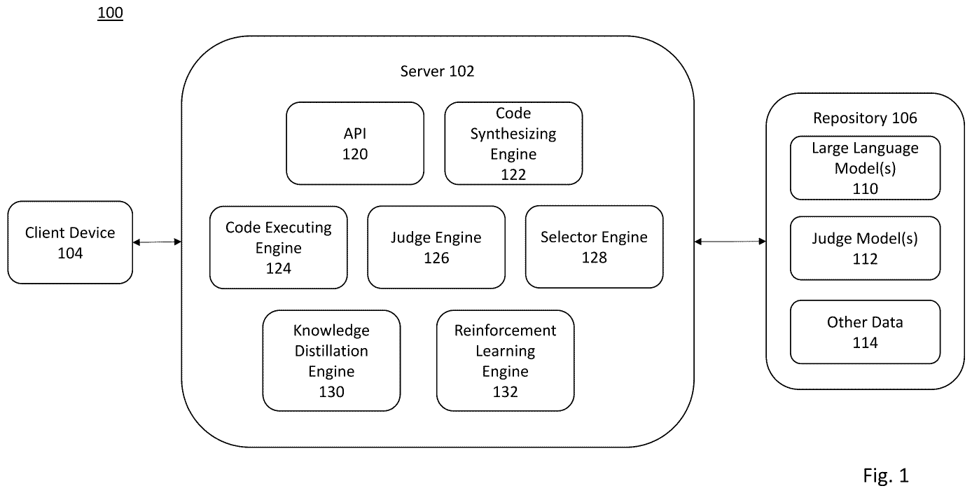

Referring to FIG. 1, a system 100 for code evaluation using a large language model 110 is provided, according to certain aspects of the present disclosure. The system 100 includes a server 102, a client device 104, and one or more repositories 106 for storing information. The server 102 and the client device 104 are computing devices with at least one processor, memory, storage device, and network interface. Examples of the client device 104 include a laptop computer, a desktop computer, a smart phone, a tablet, a phablet, a personal digital assistant (PDA), a smart television, etc. The server 102 can include one or more computing devices to perform functions described in the present disclosure.

The one or more repositories 106 can store a deep learning model, language model or large language model 110, a judge model 112, or other data 114. The one or more repositories 106 can store intermediate calculations and other data used by the server 102. The one or more repositories 106 can be housed at a separate location from the server 102 and/or owned by a different entity than the server 102. The server 102 can include multiple computing devices, networked across different physical locations, for example, by using the Internet. In some implementations, computing device(s) can host a chat interface or can receive requests via application programming interfaces for interacting with the large language model 110.

The server 102 is configured to receive requests from the client device 104. In some implementations, the requests include source code or files associated with the source code, information pertaining to the source code (e.g., a specific language associated with the source code, locations for repositories where grammar files associated with the source code are located, language-specific knowledge provided in a technical domain document, etc.), a target language, information pertaining to the target language, or any combination thereof. Examples of programming languages include COBOL, Java, C#, C++, BTEQ, PySpark, etc. In some implementations, the server 102 stores some information in the received requests in the repository 106.

In some implementations, the other data 114 is the same as or similar to some information received in the requests by the client device 104. That is, some of the information received from the client device 104 can be stored as the other data 114. For example, if the client device 104 provides a grammar file for a specific language, the grammar file can be stored in the other data 114. In another example, if the client device 104 provides a link to a depository that contains the grammar file, then the server 102 can download the grammar file and store the grammar file in the other data 114.

In some implementations, the other data 114 includes information for training the large language model 110. Any large language model can be used in embodiments of the present disclosure. Example of large language models include any version of generative pretrained transformer (GPT), large language model meta AI (LLaMA), Google Gemini, Google pathways language model (PaLM), Microsoft Orca, etc. In some implementations, the other data 114 includes information for priming the large language model 110 and/or the judge model 112. For example, a series of prompts can be provided to the large language model 110 to explain what a conversion process entails. The exact sequence and wording that should be provided in the prompts can be included in the other data 114.

In some implementations, a user of the client device 104 can perform a final analysis of the target code provided by the server 102. The user of the client device 104 can provide expert feedback to the server 102. The expert feedback can be stored as other data 114 for use in tuning the judge model 112 and/or the large language model 110.

The server 102 includes an application programming interface (API) 120, a code synthesis engine 122, a code executing engine 124, a judge engine 126, a selector engine 128, a knowledge distillation engine 130, and a reinforcement learning engine 132. Each of the API 120, the code synthesis engine 122, the code executing engine 124, the judge engine 126, the selector engine 128, the knowledge distillation engine 130, and the reinforcement engine 132 identified in FIG. 1 is a combination of hardware and software configured to perform specific functionality as described in the following paragraphs.

The API 120 of the server 102 facilitates communication between the client device 104 and the server 102. In some implementations, the API 120 also facilitates communication between the server 102 and the one or more repositories 106. The API 120 packages data packets to (and from) the client device 104, so that there is a bidirectional information flow between the server 102 and the client device 104. The API 120 can package information (e.g., expert feedback data, source code, etc.) received from the client device 104 so that these provided information can be processed by the server 102. In some implementations, the API 120 is a web service compatible with hypertext transfer protocol (HTTP) and machine-readable file formats such as extensible markup language (XML) and JavaScript object notation (JSON).

The code synthesizing engine 122 of the server 102 is configured to generate one or more code candidates using the large language model 110. The one or more code candidates can be called one or more target code in the context of code conversion. For example, if the client device 104 provides to the server 102 source code in a first language to be converted to target code in a second language, then the generated one or more candidates are one or more target code. In some implementations, the code synthesizing engine 122 generates one or more code candidates from feature specification that describes code behavior (or desired code behavior) and not from a source code. In some implementations, in test-driven development (TDD) software development practice, the code synthesizing engine 122 generates one or more code candidates from test cases (i.e., a specification of inputs, execution conditions, testing procedure, and expected results that define a single test to be executed to achieve a particular software testing objective).

In some implementations, in code conversion, the code synthesizing engine 122 performs preprocessing of the source code to determine an abstract syntax tree from the source code (e.g., source code received from the client device 104 or stored in the repository 106). An abstract syntax tree is a data structure used in compilers to represent structure of a program code. The abstract syntax tree abstracts away the syntactic details of the program code, focusing on its syntactic structure. Each node of the tree denotes a construct occurring in the program code. The code synthesizing engine 122 generates the abstract syntax tree by parsing the source code and organizing syntactical structures of the source code into a tree-like format. Each node of the tree-like format represents a different “abstract” syntactic structure of the program.

In some implementations, the code synthesizing engine 122 can use the abstract syntax tree as well as program specification generated from the source code to generate the target code. Program specifications describe intended behavior, outputs, and side effects of a program. Program specifications are formal descriptions of what a program should do. Program specifications can include function requirements, performance criteria, and constraints. The code synthesizing engine 122 generates the program specification by analyzing the source code to understand functionality of the source code, purpose of the source code, and expected behavior when the source code is executed. In some implementations, because target code should behave identically to the source code when executed, the program specifications define functionality and behavior that the target code should exhibit. Embodiments of the present disclosure are adaptable to various large language models and are thus model agnostic.

In some implementations, the code synthesizing engine 122 is an LLM code synthesizer that generates code candidates using a transformer-based architecture. The LLM code synthesizer outputs a probability distribution over the vocabulary tokens at each generation step, where the probability distribution is provided by (1).

$$P ( {x}_{i} ) = \frac{{e}^{{x}_{i}}}{{\sum }_{j = 1}^{V} {e}^{{x}_{j}}} \qquad ( 1 )$$

In (1), P(xᵢ) is the probability distribution, xᵢ is the logit for token i, and V is the vocabulary size. The LLM code synthesizer generates code by sampling from the distribution autoregressively until an end-of-sequence token is produced. The transformer-based architecture of the LLM code synthesizer supports multi-head attention and positional encoding. The LLM code synthesizer can be trained on a diverse dataset of code in order to generate code candidates based on requirements.

The code executing engine 124 of the server 102 is configured to perform various tests on the target code (or the one or more code candidates) to obtain information associated with metrics specification for assessing accuracy and/or functionality of the target code. For example, the code executing engine 124 can compile the target code to determine whether there are any compile-time errors or warnings. In some implementations, the code executing engine 124 is configured to execute the target code to obtain an output. The output can be compared with an expected output. For example, the code executing engine 124 can compile and run the source code to obtain the expected output, and the output from executing the target code is compared with the expected output. Information associated with metrics specification that can be obtained from the code executing engine 124 includes any compiler errors, edge cases, resource utilization, any compiler warnings, any artifacts observed in the output, any run-time errors, any deviation of the output from the expected output (e.g., different numerical results printed, different variable states present in both outputs, etc.).

In some implementations, the code executing engine 124 is an LLM code executor. The LLM code executor compiles and runs the target code (i.e., the code generated by the code synthesizing engine 122). In some implementations, the information associated with the metrics specification includes execution-based feedback. In some implementations, the information associated with metrics specification can include a compilation success rate, an execution success rate, an average runtime, a memory usage or some other resource utilization, or any combination thereof. The compilation success rate can be defined as a number of successfully compiled code candidates divided by a total number of code candidates. The execution success rate can be defined as a number of successfully executed code candidates divided by the total number of code candidates. The average runtime can be defined as a sum of the total runtime for the successfully executed code candidates divided by the total number of successfully executed code candidates. The memory usage can be tracked using profiling tools and averaged across executions.

In some implementations, the information associated with metrics specification is viewed differently when performing code conversion compared to code synthesis. For example, compilation success rate in the context of code conversion can be used as metric to improve iterations of the same code candidate over time, showing whether a next iteration is moving in a desired direction. That is, change in the compilation success rate is compared from one iteration to the next iteration to track improvement. On the other hand, compilation success rate in the context of code synthesis can provide information about the quality of a plurality of code candidates at a single time period. That is, code candidates with highest compilation success rates are preferred. A similar interpretation or difference can be provided for execution success rate when viewed in context of code conversion or in context of code synthesis.

Code conversion sometimes requires iterations to ensure functionality and accuracy in the target language, while code synthesis generates multiple candidates and selects the best one based on defined criteria. Code conversion follows a situation where a specific code is iterated upon over time so there are timestamps associated with different versions of the code (e.g., code 1 at time 1, code 1 at time 2, code 1 at time 3 . . . ). On the other hand, code synthesis follows a situation where code candidates (code 1, code 2, code 3 . . . ) are compared against each other at a single timestamp (e.g., at time 1). Metrics allow for comprehensive evaluation in both code conversion and code synthesis. In code conversion, change in the metrics over time allow for tracking improvements over time for generated target code. And in code synthesis, comparing metrics across different code candidates facilitates the selection of the best candidate.

The judge engine 126 of the server 102 is configured to evaluate the information associated with metrics specification obtained by the code executing engine 124. The judge engine 126 can provide scores that indicate a judgement on the information associated with metrics specification based on one or more criteria. In some implementations, the one or more criteria include code correctness, code quality, code efficiency, code maintainability, code consistency, or any combination thereof.

Code correctness involves evaluating if the code candidate successfully compiles without errors and produces the expected output for a given input set. Code correctness can further involve checking if all edge cases are handled appropriately. Code correctness can further involve checking that the code implements all required functionality as specified in a problem statement. Code Quality involves assess the code candidate's readability and structure. Code quality involves looking for proper indentation, meaningful variable names, and appropriate use of comments. Code quality can further involve evaluating the code's modularity and the use of appropriate design patterns. Code quality can further involve checking for the absence of “code smells,” such as duplicate code or overly complex methods.

Code efficiency involves analyzing the time and space complexity of the solution. Code efficiency can further involve evaluating if the code uses optimal data structures and algorithms for the given problem. Code efficiency can further involve checking for unnecessary computations or memory allocations. Code efficiency can further involve assessing the code's performance on large input sizes. Code maintainability involves evaluating the code's case of modification and extension. Code maintainability further involves looking for proper encapsulation, low coupling between modules, and high cohesion within modules. Code maintainability further involves assessing the presence and quality of unit tests. Code maintainability further involves checking whether the code follows the Single Responsibility Principle and other SOLID principles where applicable. Code consistency involves verifying that the code adheres to the specified coding standards and conventions. These standards and conventions can include consistent naming conventions, proper use of whitespace, and adherence to language-specific best practices. Code consistency can further involve ensuring that similar problems are solved in similar ways throughout the codebase.

The judge engine 126 can evaluate code candidates based on, e.g., compiler execution results, adherence to coding conventions, cyclomatic complexity, explainability via comments and documentation, maintainability and extensibility, test coverage, efficiency in time and space, or any combination thereof.

For example, one basis of evaluation is compiler execution results. Compiler execution results can include warnings and errors generated after compiling a candidate code. Therefore, the judge engine 126 can analyze compiler output for warnings and errors. In the event the compiler output includes warnings, the judge engine 126 can evaluate severity and implications of warnings. In some implementations, the judge engine 126 can check if the code compiles cleanly across different compiler versions or platforms. For example, if a code candidate is meant to be compiled using GCC 11.4 and earlier, the judge engine 126 can check compiler output on GCC 11.4 and earlier compiler versions and will not check against, for example, GCC 14.2. Similarly, if a code candidate is meant to be compiled in a specific compiler platform (e.g., .NET compiler platform), then the judge engine 126 can check compiler output for the specific compiler platform. The options for compiler version and platform can be set as parameters such that the judge engine 126 evaluates code candidates based on the specified applicable options.

In another example, adherence to coding conventions is another basis for evaluation. Adherence to coding conventions involves verifying that the code candidate follows a specified style guide. The specified style guide may include rules on bracket placement, naming conventions for variables and functions, maximum line length, and proper use of language-specific features.

In another example, cyclomatic complexity is another basis for evaluation. The judge engine 126 can calculate the cyclomatic complexity of each component (e.g., each function or method) in the candidate code. The judge engine 126 can flag any component with a complexity higher than a complexity threshold (e.g., 3, 5, 10, etc.). In some implementations, the complexity threshold is set at 10. In some implementations, the judge engine 126 can generate suggestions to refactor complex methods into smaller, more manageable pieces.

In another example, explainability via comments and documentation is another basis for evaluation. The judge engine 126 can assess the quality and completeness of code comments and documentation. For example, the judge engine 126 can check for presence of clear function headers. Function headers can include inputs to the function, outputs to the function, name of the function, etc. By identifying the function header, comment indicators can be searched for with information matching and expanding upon the inputs to the function, the outputs to the function, the name of the function, purpose of the function, etc. The judge engine 126 can check for the presence of clear function headers explaining purpose, parameters, and return values. The judge engine 126 can evaluate inline comments for complex logic. Furthermore, the judge engine 126 can verify whether README files pertaining to the code candidate or specific functions within the code candidate are present. The judge engine 126 can further verify quality of README files and other high-level documentation. For example, using a word count comparison between the length of the code candidate and the length of the README files associated with the code candidate. In some cases, when the word count comparison of a total of the README files to the code candidate is less than 20% then the README files are indicated to be of a lower quality.

In another example, maintainability and extensibility is another basis for evaluation. The judge engine 126 can evaluate maintainability and extensibility of code candidates based on a number of factors. For example, the judge engine 126 can evaluate the use of interfaces, abstract classes, and other extensibility mechanisms. The judge engine 126 can check for the presence of hard-coded values. The number of hard-coded values that should be configurable can make code inflexible for future development. Extensibility analysis involves assessing how easily new features can be added or existing features modified without significant changes to the overall structure of the code candidate.

In another example, test coverage is another basis for evaluation. The judge engine 126 can calculate the percentage of code covered by unit tests. The judge engine 126 can check whether tests exist for both normal and edge cases. In some cases, this involves checking for specific keywords in the tests. In some implementations, the judge engine 126 evaluates the quality of test assertions and flags any critical components or complex logic that lacks adequate test coverage. For example, the judge engine 126 can provide a score for each test based on the number of functions or methods in the code candidate that the test invokes.

In another example, efficiency in time and space is another basis for evaluation. The judge engine 126 can profile the candidate code's execution time and memory usage. In some implementations, this information is available based on output from the code executing engine 124. The judge engine 126 can compare against specified benchmarks (e.g., from a specification file) or can compare against one or more alternative implementations (e.g., another code candidate, a previous version of the code candidate, etc.). The judge engine 126 can identify any performance bottlenecks or memory leaks and suggest optimizations where applicable.

In an implementation, the judge engine 126 is an LLM Judge, a transformer-based architecture with operations that can be described according to (1). The LLM Judge can predict a score for each judgement criteria under consideration to obtain an overall score. For example, for each judgment criteria cᵢ, the LLM Judge predicts a score sᵢ. In some cases, the score sᵢ is a number from 1 to 10, inclusively. In some cases, the score sᵢ is a number from 1 to 100, 10 to 100, etc. The overall score S for code xᵢ can be determined as a weighted sum of each criterion's predicted score. For example, the overall score S can be determined using (2).

$$S = {{\sum }_{i = 1}}^{C} {w}_{i} {s}_{i} \qquad ( 2 )$$

In (2), wᵢ is the weight associated with criterion cᵢ, and C is the total number of criteria. The weight wⱼ for each a criterion c; based on the code xᵢ and requirements r is provided as wᵢⱼ=softmax (MLP(xᵢ; r))ⱼ. The model in (2) is trained according to (3), to minimize the mean squared error loss between the model's predictions and the ground truth scores.

$$S = - \frac{1}{N} {{\sum }_{i = 1}}^{N} {( {S}_{i} - {\hat{S}}_{i} )}^{2} \qquad ( 3 )$$

In (3), Sᵢ is the true score and Ŝᵢ is the predicted score for the i-th code candidate. The LLM Judge can also provide reasons behind its judgments in readable text format. For example, an overall score S=7 can be determined and a sentence accompanying this score can be “Explainability criteria has a score of 3, reducing the overall score to 7. The code candidate does not include comments identifying each function header's input and output variables.”

The LLM Judge can allow assessing the quality of code generated by multimodal models, taking into account both the code and the associated visual or textual content of the code. In some implementations, the system 100 supports multi-turn conversations with users of the client device 104 to provide detailed feedback, explanations, and suggestions for code improvement.

The selector engine 128 of the server 102 is configured to select a code candidate with the highest overall score S which represents a weighted combination of the LLM Judge's scores across all criteria. In some implementations, in cases of ties between the overall scores of two or more code candidates, the selector engine 128 employs additional factors such as efficiency and maintainability for breaking the tic. For example, provided that two code candidates have the same overall score, then the scores for efficiency or the scores for maintainability are compared to break the tic.

The code executing engine 124 is configured to obtain feedback and provide the feedback to the judge engine 126 and/or the knowledge distillation engine 130 for updating the large language model 110, updating a future prompt provided to the large language model 110, updating the judge model 112, and/or updating a future prompt provided to the judge model 112.

In some implementations, weights associated with the LLM Judge can be adjusted based on proxy evaluations on code quality, consistency and coherence. For example, according to (2), weights wᵢ for each criterion cᵢ can be predicted based on code requirements wᵢ=

$${e}^{{z}_{i}} / {\sum }_{j = 1}^{C} {e}^{{z}_{j}} ,$$

where zᵢ is the predicted logit for criteria cᵢ.

In some implementations, biases in LLM judging are mitigated. For example, swap augmentation is used to mitigate position bias, reference support is used to overcome knowledge limitations, and reference drop is used to avoid format bias. Bias mitigation allows the judge engine 126 to provide fair, reliable assessments across diverse code samples.

The knowledge distillation engine 130 of the server 102 is configured to tune settings of the judge engine 126 based on outputs provided by the judge engine 126. For example, the knowledge distillation engine 130 refines the LLM Judge by learning from evaluations provided by the LLM Judge. In some implementations, the knowledge distillation engine 130 is used to transfer knowledge from the LLM Judge to a student model provided by (4).

$${L}_{KD} = α * {L}_{CE} ( y , σ ( {z}_{s} ) ) + ( 1 - α ) * {L}_{CE} ( σ ( {z}_{t} / τ ) , σ ( {z}_{s} / τ ) ) \qquad ( 4 )$$

In (4), L_{CE} is the cross-entropy loss, zₜ is the logit of the teacher model, zₛ is the logit of the student model, σ is the softmax function, τ is the temperature parameter, and α is a balancing factor. The LLM Judge can be a teacher model, and a second lighter model, a student model, can be trained using (4). The student is trained to minimize a weighted sum of the cross-entropy loss with the teacher's predictions and the ground truth labels.

The reinforcement learning engine 132 of the server 102 is configured to align the large language model 110 used by the code synthesizing engine 122 for code generation with subject matter expert feedback to fine-tune the large language model 110.

The reinforcement learning engine 132 can use RLHF for the fine-tuning. For example, the reinforcement learning engine 132 uses RLHF to update policy of the large language model 110 based on the expert feedback. The reinforcement learning engine 132 can maximize an expected return provided by (5).

$$J ( θ ) = {E}_{τ ∼ {π}_{θ}} [ {{\sum }_{t = 0}}^{T} A ( {s}_{t} , {a}_{t} ) ] \qquad ( 5 )$$

In (5), J(θ) is expected return, π_{θ} is the LLM's policy with parameters θ, τ is a trajectory, aₜ is the action at time t, sₜ is the state at the time t, and A(sₜ, aₜ) is the advantage function estimated from expert feedback. The policy is updated via gradient ascent as provided in (6).

$$θ ← θ + α * {∇}_{θ} J ( θ ) \qquad ( 6 )$$

In (6), a is the learning rate.

A feedback loop involving the code synthesizing engine 122, the code executing engine 124, the judge engine 126 and the knowledge distillation engine 130 can be used to fine-tune the large language model 110 used by the code synthesizing engine 122 and the judge model 112 used by the judge engine 126. The feedback loop is an automated loop fine-tuning the large language model 110 and/or the judge model 112 such that in each iteration the code candidates provided by the code synthesizing engine 122 improve over time according to overall scores provided by the judge engine 126. In some implementations, if an iteration or loop threshold is reached, then the reinforcement learning engine 132 can use RLHF to update the large language model 110 used by the code synthesizing engine 122. The reinforcement learning engine 132 obtains expert feedback from the client device 104. The expert feedback can be in plain language, for example, “hard code the date provided in the output to January 1.” The expert feedback is used to update the large language model 110.

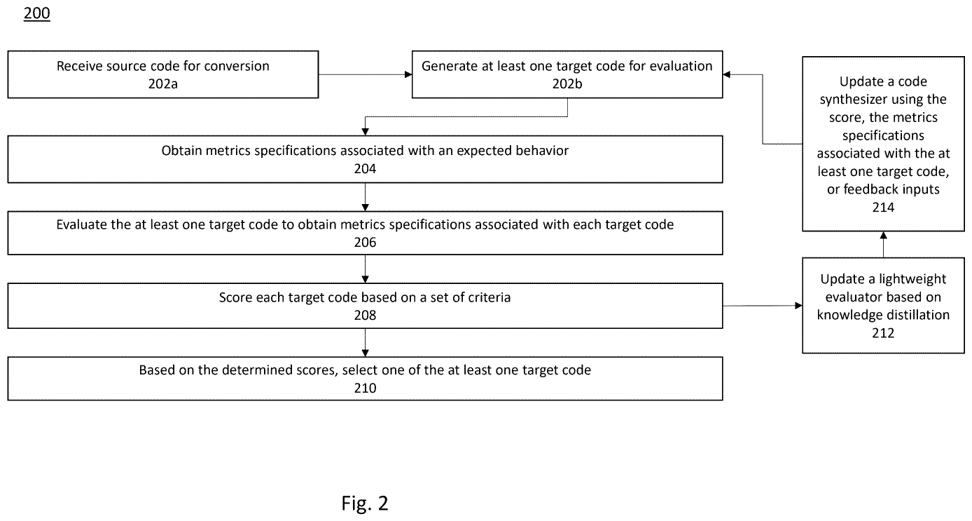

Referring to FIG. 2, a process 200 for generating code is provided, according to certain aspects of the present disclosure. The process 200 can apply to code conversion of a source code to a target code or can apply to code synthesis where one or more code candidates are generated based on an expected code behavior. The process 200 is performed by the server 102. At step 202a, the server 102 receives source code for converting to target code. The source code is written in a language different from a target language of the target code. In some implementations, the source code is divided into multiple files, for example, divided into a set of sub-documents. In some implementations, the API 120 of the server 102 receives the source code from the client device 104 and/or the repository 106.

At step 202b, the server 102 generates at least one target code for evaluation. In some implementations, the at least one target code is one or more code candidates as previously discussed in the context of code synthesis. In code synthesis, step 202a is optional. In some implementations, the at least one target code is code generated in the process for code conversion such that step 202b follows directly from step 202a.

At step 204, the server 102 obtains metrics specification associated with an expected behavior. The metrics specification can include an expected adherence to coding conventions, a measure of cyclomatic complexity, a measure of explainability via comments and documentation, a measure of maintainability and extensibility, a measure of test coverage, a measure of efficiency in time and space, a measure of compiler execution results, or any combination thereof. In code synthesizing, step 204 can be performed prior to step 202b such that the metrics specification is used in generating the at least one target code. For example, the metrics specification can include test cases of TDD software development practice or some other feature specification that describes the expected behavior of the at least one target code.

In code conversion, step 204 can be performed prior to, at the same time, or after step 202b. Obtaining the metrics specifications can include preprocessing the source code of step 202a to determine an abstract syntax tree from the source code. The metrics specifications can include the abstract syntax tree and/or expected outputs of the source code based on execution of the source code.

In some implementations, the LLM code synthesizer generates code candidates using a transformer-based language model. Given a sequence of input tokens x=(x₁, . . . , xₙ) representing the requirements, the model outputs a probability distribution over the vocabulary V at each generation step t according to (7).

$$p ( {x}_{t} \vert {x}_{< t} ) = softmax ( {h}_{t} {W}_{e} + {b}_{e} ) \qquad ( 7 )$$

In (7), hₜ is the hidden state at step t, Wₑ∈R^{d}^{_{model}}^{×|V|} and bₑ∈R^{|V|} are learned embedding weights and biases, and d_{model} is the dimension of the model's hidden states. The hidden state hₜ is computed using multi-head self-attention and position-wise feed-forward layers as provided in (8).

$${h}_{t} = Transformer ( {x}_{< t} ) \qquad ( 8 )$$

In (8), the Transformer block consists of N-stacked encoder layers, each applying multi-head self-attention followed by a feedforward layer as provided by (9).

$$Transformer ( x ) = LayerNorm ( x + FFN ( LayerNorm ( x + MultiHead ( x ) ) ) ) \qquad ( 9 )$$

$$MultiHead ( x ) = [ {head}_{1} ; … ; {head}_{h} ] \qquad ( 10 )$$

$${W}_{0} {head}_{i} = Attention ( {xW}_{i}^{Q} , {xW}_{i}^{K} , {xW}_{i}^{V} ) \qquad ( 11 )$$

$$FFN ( x ) = ReLU ( {xW}_{1} + {b}_{1} ) {W}_{2} + {b}_{2} \qquad ( 12 )$$

In the foregoing equations,

$${W}_{i}^{Q} , {W}_{i}^{K} , {W}_{i}^{V} ∈ {R}^{{d}_{model} \times {d}_{k}}$$

and Wₒ∈R^{hd}^{ₖ}^{×d}^{_{model}} are learned projection matrices, h is the number of attention heads, and dₖ=d_{model}/h is the dimension of each head. In (12), the feedforward layer FFN applies a two-layer multi-layer perceptron to each position separately. In (12), W₁∈R^{d}^{_{model}}^{×d}^{_{ff}}, b₁∈R^{d}^{_{ff}}, W₂∈R^{d}^{_{ff}}^{×d}^{_{model}}, b₂∈R^{d}^{_{model}} are learned weights and biases, and d_{ff} is the hidden dimension of the feedforward layer.

At step 26, the server 102 evaluates at least one target code to obtain metrics associated with each target code. As previously described, the server 102 performs various tests on the at least one target code (or the one or more code candidates) to obtain information associated with metrics specifications to assess accuracy and/or functionality of the at least one target code. The server 102 can execute the at least one target code to obtain an output that can be compared with an expected output. The server 102 can compile the at least one target code to obtain compiler warnings, compiler errors, etc. The server 102 can execute the at least one target code to obtain resource utilization (e.g., memory usage, CPU usage, network resource usage, etc.).

In some implementations, the LLM code executor compiles and runs the generated code collecting feedback such as compilation success rate, execution success rate, average runtime, memory usage, or any combination thereof. In some implementations, these metrics can be defined according to (13)-(16) based on a total number of code candidates N.

$$Compilation success rate : \frac{1}{N} {{\sum }_{i = 1}}^{N} [ compile ( {x}_{i} ) = success ] \qquad ( 13 )$$

$$Execution success rate : \frac{1}{N} {{\sum }_{i = 1}}^{N} [ execute ( {x}_{i} ) = success ] \qquad ( 14 )$$

$$Average runtime : \frac{1}{N} {{\sum }_{i = 1}}^{N} [ runtime ( {x}_{i} ) ] \qquad ( 15 )$$

$$Memory usage : \frac{1}{N} {{\sum }_{i = 1}}^{N} [ memory ( {x}_{i} ) ] \qquad ( 16 )$$

At step 208, the server 102 scores each target code based on a set of criteria. For example, the LLM Judge evaluates each code candidate xᵢ across C total number of criteria c₁, . . . , c_{c}. For each criterion cⱼ, the LLM Judge predicts a score sᵢⱼ=Judge (xᵢ, cᵢ). In some cases, the score sᵢ∈[1, 10]. The score sᵢⱼ can be called a component score while the score S is the overall score. The LLM Judge has a similar architecture to the transformer used in the LLM code synthesizer described using (7)-(12), but the LLM Judge includes additional criteria embedding layer and a regression head as described in (17) to (19).

$${h}_{0} = [ x ; {c}_{j} ] {W}_{c} + {b}_{c} \qquad ( 17 )$$

$${h}_{t} = Transformer ( {h}_{0} ) \qquad ( 18 )$$

$${s}_{ij} = {h}_{T} {W}_{s} + {b}_{s} \qquad ( 19 )$$

The LLM Judge is trained to minimize the mean squared error loss between predictions from the LLM Judge and the ground truth scores, for example, according to (20).

$${L}_{MSE} = {{\sum }_{i = 1}}^{N} {{\sum }_{j = 1}}^{C} {( {s}_{ij} - {\hat{s}}_{ij} )}^{2} \qquad ( 20 )$$

At step 210, based on the determined scores, one of the code candidates is selected. The code candidate with the highest score can be selected. In some implementations, the code candidates are ranked simultaneously, considering the weighted sum of criteria scores.

At step 212, the server 102 can update a lightweight evaluator (i.e., a student model) can be updated using knowledge distillation. In some implementations, the lightweight evaluator is used in later iterations for scoring. The lightweight evaluator can perform much faster than a general LLM Judge (i.e., the teacher) due to having a smaller parameter space and capturing specific task and domain information learned from the general LLM Judge. Transition from the general LLM Judge to the lightweight evaluator for scoring can be based on performance evaluations against a held-out validation set. For example, if the lightweight evaluator's performance matches or exceeds that of the general LLM Judge, the lightweight evaluator can take over the judging process. The transition is monitored over iterations, and the transition can be reversed at a future iteration if the lightweight evaluator's performance degrades over time such that the performance of the lightweight evaluator is worse than that of the general LLM Judge on the held-out validation set.

At step 214, the server 102 updates the large language model 110 used for generating code and/or the judge model 112 using the scores generated at step 208, metrics specifications obtained at step 214, and/or feedback inputs obtained via RLHF.

In some implementations, the judge model 112 includes (i) a model for the general LLM Judge, (ii) a model for the lightweight evaluator, or (iii) both (i) and (ii). The judge model 112 can be trained at regular intervals that is different from each individual score generation. For example, the judge model 112 can be trained after every three score-generating intervals. Three is used here as an example, but other interval lengths can be chosen, for example, after 10 score-generating intervals. The judge model 112 can be fine-tuned using knowledge distillation as discussed above.

In some implementations, RLHF is used to fine-tune the LLM code synthesizer based on feedback from human experts. The policy π_{θ}(a|s) maps a state s to a probability distribution over actions a. The policy is updated to maximize the expected return using (5). The LLM code synthesizer is fine-tuned using RLHF based on accumulated human expert feedback. In some implementations, the accumulated human expert feedback is processed in batches.

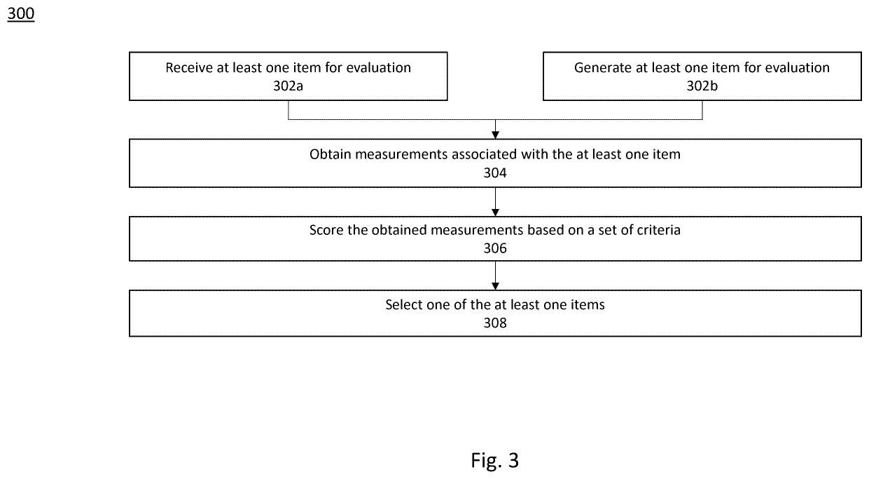

Referring to FIG. 3, a process 300 for evaluating items is provided, according to certain aspects of the present disclosure. At step 302a, an item is received for evaluation.

Alternatively, at step 302b, an item is generated for evaluation.

At step 304, measurements associated with the item are obtained.

At step 306, scores are generated for the item based on a set of criteria.

At step 308, selection of one of the items occurs.

The steps of the process 300 will be discussed in the context of several non-limiting examples. In a first example, the process 300 can be used in medical diagnosis. At step 302a, diagnostic reports can be received for evaluation at the server 102. In some cases, diagnostic predictions or other medical predictions generated from various modeling (e.g., various AI models) can be received for evaluation. In some cases, the diagnostic predictions or other medical predictions are based on patient data. Alternatively, at step 302b, the server 102 can use AI models stored in the repository 106 or some other networked location to generate the diagnostic predictions or other medical predictions.

At step 304, the diagnostic reports (or diagnostic predictions or other medical predictions) are assessed by the server 102 using one or more criteria. For example, the diagnostic reports can be assessed for accuracy, coverage of symptoms, adherence to medical guidelines, and patient history. Information associated with the one or more criteria can be stored in the repository 106 or provided by the client device 104. In some cases, accuracy involves checking names of symptoms or other information in the diagnostic reports for misspellings. In some cases, coverage of symptoms involves determining whether respective diagnostic reports address all symptoms experienced by the patient. Coverage of symptoms can also involve assessing a percentage of symptoms or a number of symptoms covered by each of the diagnostic reports. In some cases, adherence to medical guidelines involves comparing a formatting associated with each diagnostic report to an accepted guideline for a specific medical field or domain and/or for a specific medical entity (e.g., a local hospital's form). In some cases, patient history involves checking the diagnostic reports to be certain that the diagnostic reports are compatible with information included in the patient's history. In some cases, a subset of the patient's history is used for the comparison.

At step 306, scores are generated by the judge engine 126 of the server 102 based on the assessments or measurements performed in step 304. For example, the judge engine 126 can generate component scores based on the assessments. For example, the judge engine 126 can generate diagnostic accuracy scores based on the accuracy assessment of each of the diagnostic reports, comprehensiveness scores based on the coverage of symptoms assessment, and relevance scores based on patient history and/or adherence to medical guidelines assessments. These component scores can be combined to provide total scores associated with each of the diagnostic reports (see e.g., step 208).

At step 308, based on the total score associated with each of the diagnostic reports, the selector engine 128 chooses the diagnostic report with the best total score. The best total score is indicative of the diagnostic report that provides the most accurate and thorough assessment.

Although FIG. 3 deals with selecting among several diagnostic reports, in some implementations, as discussed above in connection with steps 212 and 214 of FIG. 2, analogous processes can be used to fine-tune the judge engine 126 and/or AI models stored in the repository 106 used to generate diagnostic reports. For example, the knowledge distillation engine 130 can be used for fine-tuning the judge engine 126. RLHF can be used for fine-tuning the AI models for the specific task of generating diagnostic reports. In some implementations, these fine-tuning can help improve accuracy of the system 100 the next time diagnostic report candidates are generated to be compared against each other. FIG. 3 deals with comparing different diagnostic report candidates from different AI models to choose a “best” candidate (analogous to code synthesis situation discussed above). In some implementations, the fine-tuning can help with training a specific AI model over time to generate a more accurate diagnostic report (analogous to code conversion situation discussed above).

In a second example, the process 300 can be used in fraud detection. At step 302a, fraud detection models or rules can be obtained. Fraud detection models or rules are test conditions used to flag whether a certain activity is fraudulent or not fraudulent.

At step 304, each of the fraud detection models is measured or assessed based using one or more criteria. For example, the fraud detection models can be measured on detection accuracy, false positive rate, false negative rate, computational efficiency, etc. These measurements can be obtained using sample test data such that all the fraud detection models undergo testing in a same data environment. In some cases, accuracy takes into account true positives, true negatives, false positives, and/or false negatives. In some cases, computational efficiency is measured in terms of an elapsed duration for receiving a response (or hardware resource requirements associated with generating a response).

At step 306, scores are generated for each of the fraud detection models. In some cases, component scores are generated for each of the assessments at step 304. For example, accuracy, false positives, false negatives, and computational efficiency can be normalized to numbers between 0 and 1. These composite scores between 0 and 1 can be combined to generate total scores for the fraud detection models.

At step 308, based on the total score associated with each of the fraud detection models, the selector engine 128 chooses the fraud detection model with the best total score. The best total score is indicative of the fraud detection model with the best performance and efficiency.

In a third example, the process 300 can be used in curriculum development. At step 302a, multiple curriculum proposals are received for evaluation at the server 102. Optionally, at step 302b, the curriculum proposals can be automatically generated.

At step 304, the multiple curriculum proposals can be measured or assessed based on coverage of key topics, alignment with educational standards, and student engagement potential. These criteria are merely provided as examples and can be specified in one or more text files.

At step 306, scores are generated for each of the curriculum proposal by the judge engine 126. As in previous examples, the scores are numerical measures that allow comparison of the different curriculum proposals.

At step 308, the selector engine 128 chooses the curriculum that best meets educational goals and standards.

Embodiments of the present disclosure provide systems and methods that offer a significant advancement in code synthesis and evaluation. By integrating LLM-based code generation, execution, judging with knowledge distillation, LLM-based weights, RLHF, and bias mitigation techniques, the systems and methods provide a comprehensive, efficient and adaptive solution to the complex challenges of generating high-quality, consistent code that meets functional and non-functional requirements. The detailed criteria considered by the LLM Judge ensure the selected code is not just correct, but also maintainable, efficient, well-documented and tested. Embodiments of the present disclosure have the potential to greatly accelerate software development while ensuring exceptional code quality.

Embodiments of the present disclosure provides systems and methods that use LLMs for code synthesis, conversion, and quality assessment. In some implementations, the LLM code synthesizer can generate code based on input requirements. In some implementations, an LLM Juge is used to evaluate generated code based on various criteria such as correctness, efficiency, maintainability, and adherence to coding conventions. The LLM Judge can be trained using knowledge distillation, LLM-based weights, and RLHF. Embodiments of the present disclosure allow using LLMs for advanced code generation, understanding, and evaluation capabilities, enabling the system to produce high-quality, maintainable code that meets user requirements. The system can mitigate position bias, knowledge bias, and format bias via swap augmentation, reference support, and reference drop. Swap augmentation can involve training the LLM Judge on both original and swapped orders of code candidates. Reference support can involve providing the LLM Judge with external knowledge relevant to the coding task. Reference drop can involve randomly excluding reference information during training, enabling the LLM Judge to evaluate code with or without reference.

The system can retain multi-turn conversation abilities of the base LLMs, allowing users to engage in detailed discussions about the generated code and its evaluation. The present disclosure offers a more comprehensive, efficient and adaptive approach to code synthesis and evaluation by leveraging advanced capabilities of LLMs and incorporating execution-based feedback and multi-criteria optimization.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A system, comprising:
one or more data processors; and
a non-transitory computer-readable storage medium containing instructions which, when executed on the one or more data processors, cause the one or more data processors to perform operations including:
obtaining metrics specifications associated with an expected behavior,
generating one or more code candidates,
evaluating the one or more code candidates to obtain metrics specifications associated with each of the one or more code candidates,
scoring each of the one or more code candidates based on a set of criteria, and
based on the determined scores, selecting a target code from the one or more candidates.

2. The system according to claim 1, wherein executing the instructions further cause the one or more data processors to perform the operations including:
receiving source code in a first programming language, wherein the generated one or more code candidates are in a second programming language different from the first programming language.

3. The system according to claim 1, wherein the metrics specifications associated with an expected behavior include an expected adherence to coding conventions, a measure of cyclomatic complexity, a measure of explainability via comments and documentation, a measure of maintainability and extensibility, a measure of test coverage, a measure of efficiency in time and space, a measure of compiler execution results, or any combination thereof.

4. The system according to claim 1, wherein the metrics specifications associated with each of the one or more code candidates includes a compilation success rate, executions success rate, average runtime, memory usage, or any combination thereof.

5. The system according to claim 1, wherein the scoring each of the one or more code candidates is based on a large language model judge trained to predict a respective component score associated with a respective criterion in the set of criteria.

6. The system according to claim 5, wherein the large language model judge includes a criteria embedding layer and a regression head.

7. The system according to claim 5, wherein executing the instructions further cause the one or more data processors to perform the operations including:
fine-tuning the large language model judge to evaluate the generated one or more code candidates using knowledge distillation, reinforcement learning with human feedback, and/or large language model based weight modification.

8. The system according to claim 7, wherein the large language model judge is trained to minimize a mean squared error loss associated with the scoring of each of the one or more code candidates.

9. The system according to claim 7, wherein the large language model judge is trained using reference dropping.

10. The system according to claim 7, wherein a lightweight evaluator is trained using knowledge distillation to transfer knowledge from the large language model judge such that the lightweight evaluator performs subsequent scoring of the one or more candidates.

11. The system according to claim 10, wherein the lightweight evaluator is trained to minimize a sum of cross-entropy loss with predictions of the large language model judge and a ground truth.

12. The system according to claim 1, wherein the one or more code candidates are generated based on a large language model code synthesizer, wherein the large language model code synthesizer is trained based on input requirements using a transformer-based architecture with multi-head attention and positional encoding.

13. The system according to claim 1, wherein one or more code candidates are evaluated based on a large language model code executor.

14. The system according to claim 1, wherein the set of criteria includes compiler execution results, adherence to coding conventions, cyclomatic complexity, explainability via comments and documentation, maintainability and extensibility, test coverage, efficiency in time and space, or any combination thereof.

15. The system according to claim 1, wherein the one or more code candidates are scored in different order using swap augmentation.

16. The system according to claim 1, wherein the one or more code candidates are scored using reference support relevant to a coding task.

17. A method comprising:
obtaining metrics specifications associated with an expected behavior;
generating one or more code candidates;
evaluating the one or more code candidates to obtain metrics specifications associated with each of the one or more code candidates;
scoring each of the one or more code candidates based on a set of criteria; and
based on the determined scores, selecting a target code from the one or more candidates.

18. The method according to claim 17, further comprising:
receiving source code in a first programming language, wherein the generated one or more code candidates are in a second programming language different from the first programming language.

19. The method according to claim 17, wherein the metrics specifications associated with an expected behavior include an expected adherence to coding conventions, a measure of cyclomatic complexity, a measure of explainability via comments and documentation, a measure of maintainability and extensibility, a measure of test coverage, a measure of efficiency in time and space, a measure of compiler execution results, or any combination thereof.

20. The method according to claim 17, wherein the metrics specifications associated with each of the one or more code candidates includes a compilation success rate, executions success rate, average runtime, memory usage, or any combination thereof.
